(19) United States
(12) Patent Application Publication
(10) Pub. No.: US 2023/0192081 A1
(43) Pub. Date: Jun. 22, 2023

(54) METHOD FOR CONTROLLING A DISTANCE-DEPENDENT CRUISE CONTROL SYSTEM

(71) Applicant: Robert Bosch GmbH, Stuttgart (DE)

(72) Inventors: Alexander Lengsfeld, Bad Muender (DE); Philip Lenz, Holle (DE)

(21) Appl. No.: 18/056,334

(22) Filed: Nov. 17, 2022

(30) Foreign Application Priority Data
Dec. 16, 2021 (DE) 10 2021 214 509.4

(51) Int. Cl. B60W 30/14

(52) U.S. Cl. CPC B60W 30/14; B60W 2420/42; B60W 2552/00; B60W 2554/80

(57) ABSTRACT

A method for controlling a distance-dependent cruise control system for a motor vehicle, pieces of distance information and/or pieces of velocity information of a target object being combined with pieces of context information. The velocity of the motor vehicle is controlled as a function thereof.

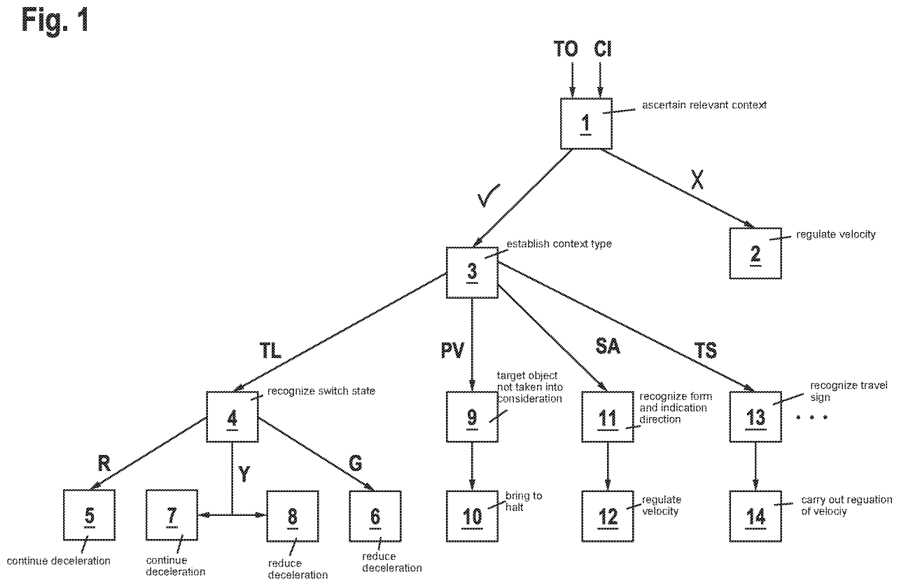

### CROSS REFERENCE

The present application claims the benefit under 35 U.S.C. § 119 of German Patent Application No. DE 10 2021 214 509.4 filed on Dec. 16, 2021, which is expressly incorporated herein by reference in its entirety.

### FIELD

The present invention relates to a method for controlling a distance-dependent cruise control system for a motor vehicle in which pieces of context information are used.

A distance-dependent cruise control system is referred to as an adaptive cruise control system here. Additionally, a signaling system is referred to, in simplified terms, as a traffic light.

### BACKGROUND INFORMATION

Adaptive cruise control (ACC) systems regulate the velocity of a motor vehicle as a function of a distance from a target object, for example a further vehicle situated ahead of the motor vehicle. Moreover, the velocity of the target object may be taken into consideration during the regulation. The pieces of distance information, and possibly the pieces of velocity information, are typically detected with the aid of radar sensors. Conventional adaptive cruise control systems thus exclusively consider the target object itself and possibly further target objects in the surroundings. In the conventional adaptive cruise control systems, the following situations mentioned by way of example are assessed equally, and a similar regulation of the velocity takes place:
approaching a parking vehicle;
approaching a traffic jam;
approaching a vehicle waiting at a traffic light.

In conventional adaptive cruise control systems, pieces of context information about the situation are not taken into consideration. Pieces of context information are situation-dependent pieces of information about the surroundings in a situation, which are obtained from various sources, such as, for example, sensors, and from which conclusions may be drawn about the context. The context may be defined as a relationship in terms of facts or meaning, which is derived from various pieces of information to describe a situation. A simple object detection by itself thus does not represent a piece of context information. Only the combination of multiple detections or pieces of information results in a piece of context information. For example, it is not possible from the detection of traffic lanes alone to provide information about which lane the motor vehicle is driving in, and what the model of the traffic lanes in the particular situation looks like. Information may only be provided about this by the additional classification of individual traffic lanes, i.e., for example, in the ego-lane, left lane and right lane. The context thus arises from the combination of various detections or pieces of information, which are correlated with one another. The pieces of context information may be used to control application programs.

Of late, video systems in the low-price sector have become available which are able to ascertain pieces of context information.

### SUMMARY

According to an example embodiment of the present invention, a method for controlling a distance-dependent cruise control system for a motor vehicle is provided, pieces of distance information and/or pieces of velocity information of a target object being combined with pieces of context information, and the velocity of the motor vehicle being controlled as a function thereof.

The pieces of context information are advantageously obtained via a video system of the motor vehicle. Already available video systems in the low-price sector are able to detect pieces of information about a scene context. In the process, for example, traffic lights and their control, vehicle signals, such as, for example, brake lights and turn signals, lane markings, such as, for example, lane boundaries, arrows and more complex lane markings, and the like may be recognized. The video system is, generally speaking, not limited to the low-price sector. It is also possible to use more complex video systems. In particular, video-radar fusion systems may be used, which are already being used for other driver assistance systems in motor vehicles.

The pieces of context information include, in particular, pieces of information about the traffic infrastructure. The traffic infrastructure includes, for example, signaling systems (traffic lights) and their switch state (red, yellow, green, possibly also the combinations red-yellow, green-yellow and/or flashing lights), traffic signs, such as, for example, “right of way,” “yield” and “Stop. Yield” (stop sign), and roadway markings, such as, for example, stop lines, lane markings and turn arrows. The traffic infrastructure may furthermore include one or multiple of the following examples:
railroad crossing;
crosswalk;
traffic island;
traffic circle;
intersection or junction with “priority to the right” rule.

The respective context type, i.e., what type of traffic infrastructure is involved, may be ascertained from the pieces of context information.

Hereafter, a context-dependent control of the velocity by the adaptive cruise control system is described for three exemplary scenarios.

According to an example embodiment of the present invention, when a parking vehicle is approached, the adaptive cruise control system preferably only intervenes at a small distance, and does not reduce the velocity until a late stage. With a sufficient roadway width and without relevant oncoming traffic, a driver would typically drive past such a parking vehicle. The adaptive cruise control system preferably only intervenes when no reaction by the driver may be assumed, and an intervention furthermore results in a safe stopping in the comfort zone.

At the end of a traffic jam, the adaptive cruise control system preferably already intervenes at a larger distance and reduces the velocity at an early stage. In this way, the vehicle comes to a halt in a timely manner with a lowest possible deceleration, which is perceived as comfortable by the driver. Moreover, in this way it is signaled to the driver that the adaptive cruise control system has recognized the situation and is carrying out a corresponding regulation.

When a traffic light is being approached, the adaptive cruise control system preferably intervenes as a function of the switch state of the traffic light, i.e., the displayed color. If the traffic light is red, the adaptive cruise control system preferably already intervenes at a larger distance and reduces the velocity at an early stage. In this way, the vehicle comes to a halt in a timely manner with a lowest possible deceleration. Moreover, it is also signaled to the driver here that the adaptive cruise control system has recognized the situation and is carrying out a corresponding regulation. When switching from red to yellow or to red-yellow, it is expected that the traffic light will promptly switch to green, and the velocity is maintained as consistently as possible. In the process, the distance with respect to the preceding vehicle may become smaller. A so-called “immersion” into the distance with respect to the preceding vehicle, as selected by the driver, may take place. When switching from green to yellow, it is expected that the traffic light will promptly switch to red, and the velocity is reduced as soon as possible. In this way, the distance with respect to the preceding vehicle is increased.

By incorporating the pieces of context information, which represent the present traffic situation, into the distance-dependent cruise control system (adaptive cruise control system), a behavior as would be expected of a driver (human-like behavior) is replicated. This improves the user experience.

For the described method for controlling the distance-dependent cruise control system, the use of a map and/or the creation of a complex surroundings model which is as complete as possible may be dispensed with for the analysis of the situation. Consequently, also no all-around detection of the surroundings of the motor vehicle is required, but a pure frontal view of the surroundings is sufficient. This may already be achieved with few, in particular one, frontally oriented video sensor or sensors, such as are already used with video systems in the low-price sector.

Moreover, no trajectory planning is necessary, which is usually very computationally intensive. In this way, the computing time is considerably reduced compared to conventional driver assistance systems, which incorporate the pieces of context information directly into the trajectory planning, and nonetheless a comparable user experience is created in the low-price sector.

As a result, the described method for controlling the distance-dependent cruise control system allows the user experience, with respect to the regulation of the adaptive cruise control system, to be already achieved with the aid of video systems and computing powers in the low-price sector, such as is only customary in the high-price sector with conventional systems.

According to an example embodiment of the present invention, the method according to the present invention for controlling a distance-dependent cruise control system may be integrated into existing electronic control units. For this purpose, the method may be implemented directly into the electronic control unit or may be installed on an encapsulated component which is coupled to the control unit. The implementation is also possible subsequently in the form of a software update.

### BRIEF DESCRIPTION OF THE DRAWINGS

Exemplary embodiments of the present invention are shown in the FIGURE and are described in greater detail in the following description.

The FIGURE shows a flowchart of one exemplary embodiment of the method according to the present invention.

### SUMMARY

The following exemplary embodiments relate to a motor vehicle which includes an adaptive cruise control system and a video system including a frontally oriented video sensor.

The video sensor records, on the one hand, pieces of target information TO, i.e., pieces of information about the distance and/or the velocity of the vehicle situated ahead thereof, and, on the other hand, pieces of context information CI. The relevant context is ascertained 1 from the pieces of context information CI. When the motor vehicle approaches a traffic light in one example, the traffic light and its switch state are initially recognized from a larger distance, for example from more than 200 m. If stationary target objects are detected from the pieces of target information TO, it may be assumed that these are waiting at a red traffic light. An object detection in a camera image is dependent, in its detection range, on the real object size. For example, a motor vehicle has a width of approximately 1.8 m, while a traffic light is only 0.2 m wide. For this reason, it is possible to recognize a motor vehicle already from a larger distance than a traffic light, for example 100 m earlier. Moreover, it is to be assumed that, based on typical traffic rules, parking is not permitted in the area ahead of traffic lights. The adaptive cruise control system carries out a slight deceleration of the motor vehicle.

If no context relevant for the regulation is detected during the ascertainment 1, the regulation of the velocity is carried out 2 regardless of the context. If a relevant context is detected, initially the context type is established 3. The context type results from the sum of the pieces of context information CI or the pieces of surroundings information. The following context types are listed here by way of example, it also being possible for further context types to be provided:
a traffic light TL including its switch states R, G, Y;
a street arrow SA;
a traffic sign TS;
a parking vehicle PV.

If the context type is established 3, for example, to be a traffic light TL, the switch state of traffic light TL is recognized 4. In this example, the switch state of traffic light TL is limited to red R, yellow Y, and green G for simplification. If traffic light TL shows red R, the deceleration of the motor vehicle is continued 5 until the motor vehicle comes to a halt behind the vehicle situated ahead thereof. If traffic light TL shows green G, the deceleration is reduced 6, if the distance with respect to the target object is still large enough, since it may be expected that the vehicle situated ahead will start. If traffic light TL shows yellow Y, the regulation takes place as a function of whether the transition from red R to yellow Y or from green G to yellow Y has taken place. Oftentimes this is apparent in the case of traffic lights TL from the fact that the preceding color is also displayed, in particular in the case of the combination red-yellow. During a transition from green G to yellow Y, the deceleration is continued 7 since it may be assumed that the vehicle situated ahead will stop at traffic light TL. During a transition from red R to yellow Y, the deceleration is reduced 8, if the distance with respect to the target object is still large enough, since it may be expected, as in the case of green G, that the vehicle situated ahead will start. If the driver takes over the control, it is additionally pointed out to the driver that the switch state of traffic light TL has changed, for example by a corresponding display.

If establishment 3 of the context type shows a parking vehicle PV as the target object, in particular without a traffic light TL being present, the target object is not taken into consideration 9 during the regulation as long as safe stopping is still possible with a predefined maximum deceleration, for example, 3.5 m/s². If the point at which safe stopping is just barely still possible is reached, the motor vehicle is brought to a halt 10 in a timely manner using a comfort maneuver. If the driver reacts before that, no regulation is carried out by the adaptive cruise control system. Moreover, further pieces of information may be utilized for a better analysis of the situation. For example, potentially present oncoming traffic may be detected and/or the lane or roadway width may be ascertained. From these pieces of information, a bottleneck may be detected, which the motor vehicle is not able to pass, and early stopping may be regulated. An early warning of the driver is also possible.

If the context type is established 3 to be a street arrow SA, the arrow, most notably the form (single arrow, double arrow) and the indicated direction, are recognized 11. A regulation of the velocity is then carried out 12 corresponding to street arrow SA.

If the context type is established 3 to be a traffic sign TS, the traffic sign, most notably the outer shape, the color and/or the depicted forms or pictograms, are recognized 13. A regulation of the velocity is then carried out 14 corresponding to traffic sign TS.

Moreover, pieces of information from a map may be integrated into the system. In the process, pieces of context information, for example about traffic signs, stop lines and/or underlying traffic rules such as “priority to the right” are obtained.

In this exemplary embodiment of the present invention, the evaluation for each time step takes place individually. In other exemplary embodiments, it is also possible for a temporal smoothing of the control variables, and thus of the vehicle behavior, to take place. The smoothing may be easily integrated into the existing control system. In still other exemplary embodiments, a temporal consideration of the scenarios takes place. This results in a further improvement of the overall system, beyond the pure smoothing of the vehicle reaction. As examples, regulations 5 through 8 could be adapted by assessing the duration of switch states R, G, Y of traffic light TL in that, for example, the deceleration 5 is less in the case of a red phase R that has already lasted a long time than directly after the transition to red R.

What is claimed is:

1. A method for controlling a distance-dependent cruise control system for a motor vehicle, the method comprising:
combining pieces of distance information and/or pieces of velocity information of a target object combined with pieces of context information; and
controlling the velocity of the motor vehicle being controlled as a function of the combination.

2. The method as recited in claim 1, wherein the pieces of context information are obtained via a video system of the motor vehicle.

3. The method as recited in claim 1, wherein the pieces of context information include pieces of information about traffic infrastructure.

4. The method as recited in claim 1, wherein the pieces of context information include pieces of information about signaling systems and their switch states.

5. The method as recited in claim 1, wherein the pieces of context information include pieces of information about one or multiple of the following traffic infrastructures:
traffic sign;
railroad crossing;
crosswalk;
traffic island;
traffic circle;
intersection or junction with “priority to the right” rule;
roadway markings;
stop lines; and
lane markings and turn arrows.
